(19) United States
(12) Patent Application Publication
(10) Pub. No.: US 2016/0350658 A1
(43) Pub. Date: Dec. 1, 2016

(54) VIEWPORT-BASED IMPLICIT FEEDBACK

(71) Applicant: Microsoft Technology Licensing, LLC, Redmond, WA (US)

(72) Inventors: Gautam Kedia, Redmond, WA (US); Kieran McDonald, Redmond, WA (US); Qi Guo, Redmond, WA (US); Abhishek Jha, Redmond, WA (US); Karan Singh Rekhi, Redmond, WA (US); Zachary Kahn, Redmond, WA (US); Aidan Crook, Redmond, WA (US)

(73) Assignee: MICROSOFT TECHNOLOGY LICENSING, LLC, Redmond, WA (US)

(21) Appl. No.: 14/727,026

(22) Filed: Jun. 1, 2015

(51) Int. Cl. G06N 5/04; G06F 3/0481; G06N 99/00; G09G 5/14

(52) U.S. Cl. CPC G06N 5/04; G09G 5/14; G06F 3/0481; G06N 99/005

(57) ABSTRACT

Examples of the present disclosure describe systems and methods for improving the recommendations provided to a user by a recommendation system using viewed content as implicit feedback. In some aspects, attention models are created/updated to infer the user attention of a user that has viewed or is viewing content on a computing device. The attention model may be used to convert inferences of user attention into inferences of user satisfaction with the viewed content. The inferences of user satisfaction may be used to generate inferences of fatigue with the viewed content. The inferences of user satisfaction and inferences of user fatigue may then be used as implicit feedback to improve the content selection, content triggering and/or content presentation by the recommendation system. Other examples are also described.

### BACKGROUND

Recommendation systems are applications that involve predicting user responses to options and user intentions for queries. Although various technologies and approaches have evolved to solicit feedback from users for the recommendation systems, these solutions have relied on explicit user feedback. As a result, these solutions have been unable to provide reliable implicit feedback in order to improve the recommendation systems.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Examples of the present disclosure describe systems and methods for improving the recommendations provided to a user by a recommendation system using viewed content as implicit feedback. In some aspects, attention models are created and/or updated to infer\user attention based at least upon content that the user has viewed or is viewing on a computing device. The attention model may be used to generate inferences of user attention into inferences of user satisfaction with the viewed content. The inferences of user satisfaction may be used to generate inferences of fatigue with the viewed content. The inferences of user satisfaction and inferences of user fatigue may then be used as implicit feedback to improve the content selection, content triggering and/or content presentation by the recommendation system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview an example system for improving recommendations from implicit feedback as described herein.

FIGS. 2A and 2B are diagrams of a client computing device and server, respectively, as described herein.

FIG. 3 illustrates the diagram of exemplary viewed content as described herein.

FIG. 4 illustrates an example method of improving recommendations based at least upon implicit user feedback as described herein.

FIG. 5 illustrates an example method of creating and/or updating an attention model.

FIG. 6 illustrates an example method of creating and/or updating a satisfaction model.

FIG. 7 illustrates an example method of creating and/or updating a fatigue model.

FIG. 8 illustrates an example method of improving recommendation content as described herein.

FIG. 9 is a block diagram illustrating an example of a computing device with which aspects of the present disclosure may be practiced.

FIGS. 10A and 10B are simplified block diagrams of a mobile computing device with which aspects of the present disclosure may be practiced.

FIG. 11 is a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods for improving the electronic recommendations provided to a user by a recommendation system. Improvements may be based implicit feedback. The implicit feedback may be determined based upon content viewed by a user. In examples, a recommendation system may be distributed among one or more computing devices and 1) uses a user's viewed content data to create satisfaction and/or fatigue models. The satisfaction and/or fatigue models may be used to improve the quality of the electronic recommendations. A recommendation system, as used herein, may be one or more information filtering software components that attempts to predict a user's preference, feedback and/or intention based upon the user's implicit and explicit input. In examples, a client computing device tracks content viewed by a user. The viewed content may then be provided to the recommendation system. Viewed content, as used herein, may refer to the one or more viewports that define the user viewing experience. A viewport, as used herein, may refer to a text content, video content, audio content, one or more display images or some combination thereof within a viewing region on a display screen. A viewport may comprise a card, a portion of a card, multiple portions of multiple cards, an image, text, document and/or webpage objects, etc. A card, as used herein, may refer to a message or notification that is displayed on a display screen and that indicates information relevant an action received from a user, location or query. For example, a card may display the weather for a particular location, information about a sports teams, recent news events, or nearby movie theatres and movie times related to the user's search query for a particular movie. One of skill in the art will appreciate that, while specific examples of information are provided herein, other types of information may be included on a card without departing from the scope of this disclosure.

In aspects, the recommendation system creates one or more attention models to infer user attention from the viewed content. A model, as used herein, may refer to a structure of organized data elements that standardize the manner by which the data elements relate to each other. For example, a model may be a rule-based model, a machine-learned regressor, a machine-learned classifier, etc. The attention models interpret and convert the viewed content into accurate and useful interpretations of user attention. For example, the attention models may attribute the duration of each card within a viewport based on the visible area of each card within the viewport. The duration of a card may refer to the amount of time the card, or portions thereof, was visible within a viewport. The duration of a card may be attributed by determining the amount of time the card, or portions thereof, was visible within one or more viewports. After the attention models have been attributed for one or more cards in one or more of the viewports, the attention models may aggregate the attributed cards to obtain the cumulative user attention for a card. The cumulative user attention, as used herein, may refer to the total amount of time a card was visible within all viewports the card appeared. The cumulative user attention may be calculated by adding the durations of time a card was visible in each viewport of a user's viewed content.

The recommendation system may use the data interpreted by the attention models to create one or more satisfaction models to infer user satisfaction. The satisfaction models convert inferences of user attention into inferences of user satisfaction of the viewed content or satisfaction with the type of viewed content. For example, the satisfaction models may normalize the attention model data by content density. Normalization, as used herein, may refer to the creation of shifted and/or scaled versions of statistical data, where the shifted and/or scaled values allow for the comparison of corresponding values for different datasets in a way that eliminates/mitigates the effects of certain influences. Content density, as used herein, may refer to the ratio or percentage of content within a viewing area in relation to the size of that viewing area. The normalized attention data may then be used to determine optimal thresholds for inferring user satisfaction with viewed content. Satisfaction models may be trained, at least in part, using these optimal thresholds.

The recommendation system may use the satisfaction models or the inferred satisfaction data to create one or more fatigue models to infer user fatigue. The fatigue models use inferences of user satisfaction with viewed data to determine if/when the relevance of the viewed content may become degraded to the user. Degraded content, as referred to herein, may refer to content that no longer satisfies the user or satisfies the user to a lesser degree than when the content was previously viewed. Content may be degraded due to time lapse, due to changing interests, or because the content has been repeatedly viewed, but not updated. For example, the fatigue models may determine when viewed content has been modified and/or updated. The fatigue models may then determine that the information associated with the viewed content is no longer current and is therefore no longer relevant or useful to the user. Accordingly, a fatigue score may be generated and/or the fatigue models may be trained to degrade the relevance of the viewed content.

The recommendation system may use the inferred satisfaction data and/or the inferred fatigue data as implicit user feedback. Implicit feedback, as used herein, may refer to user data that indirectly reflects opinions through observations of user behavior, user interests, or user preferences. Implicit feedback may be used to improve the recommendation system, which is generally highly personalized and contextualized and may not easily obtain feedback to improve performance otherwise. For example, using implicit feedback, the recommendation system may improve the content selection, content triggering, content ranking and/or the content presentation of recommendations. These improvements improve the user experience for users of the recommendation system by, for example, allowing the recommendation system to proactively provide accurate recommendations to users.

Accordingly, the present disclosure provides a plurality of benefits including but not limited to: automatic recommendation generation from implicit user feedback; minimizing the need for developers/programmers to rely on user “click” signals; increased accuracy of contextual recommendation selection, triggering, and ranking; improved presentation of recommendations within a display area; improved efficiency and reliability for applications interfacing with the recommendation system, among other examples.

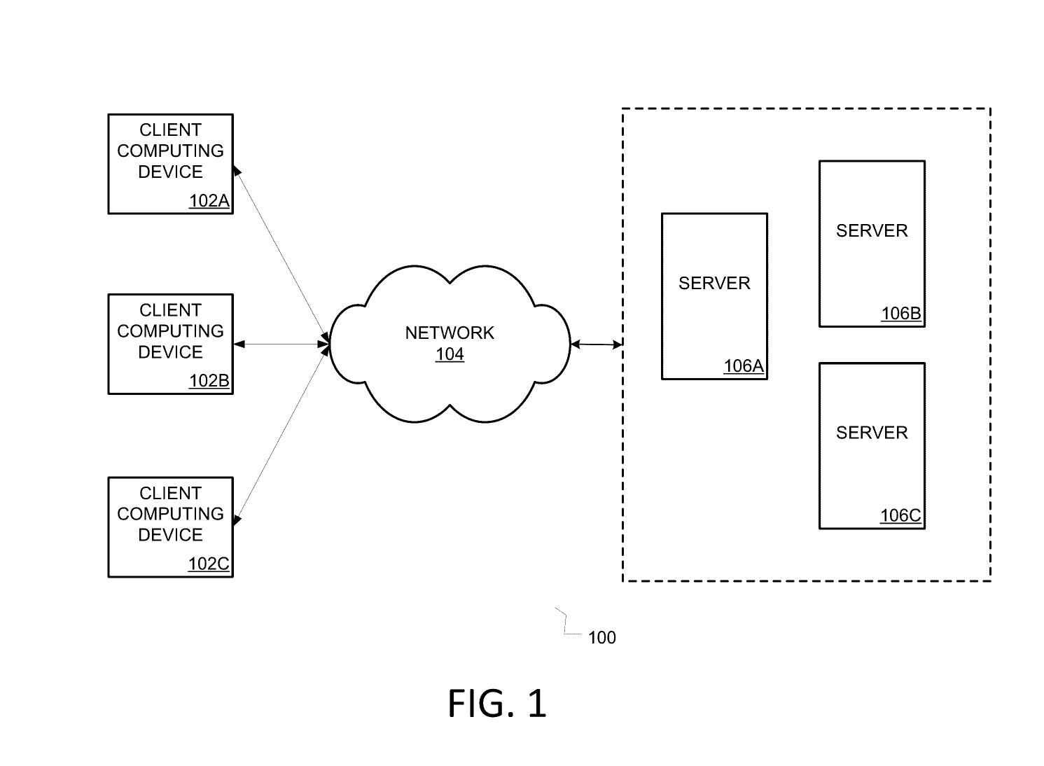

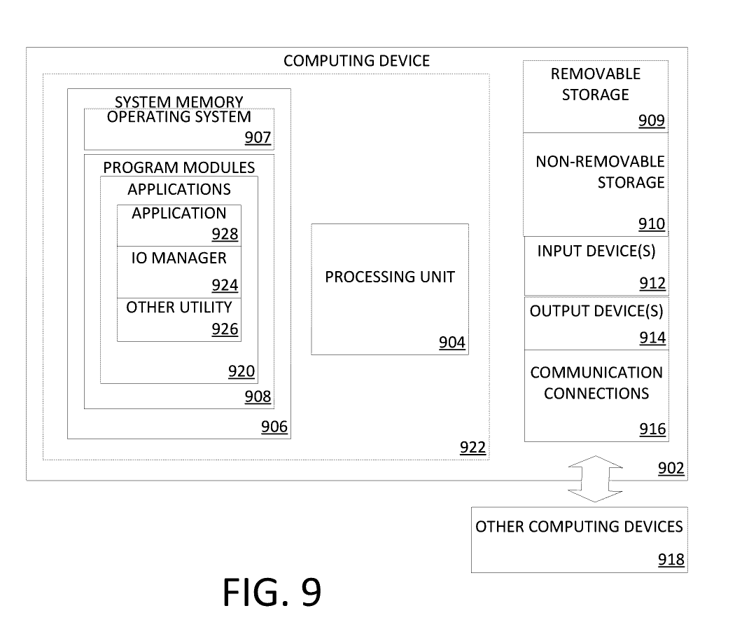

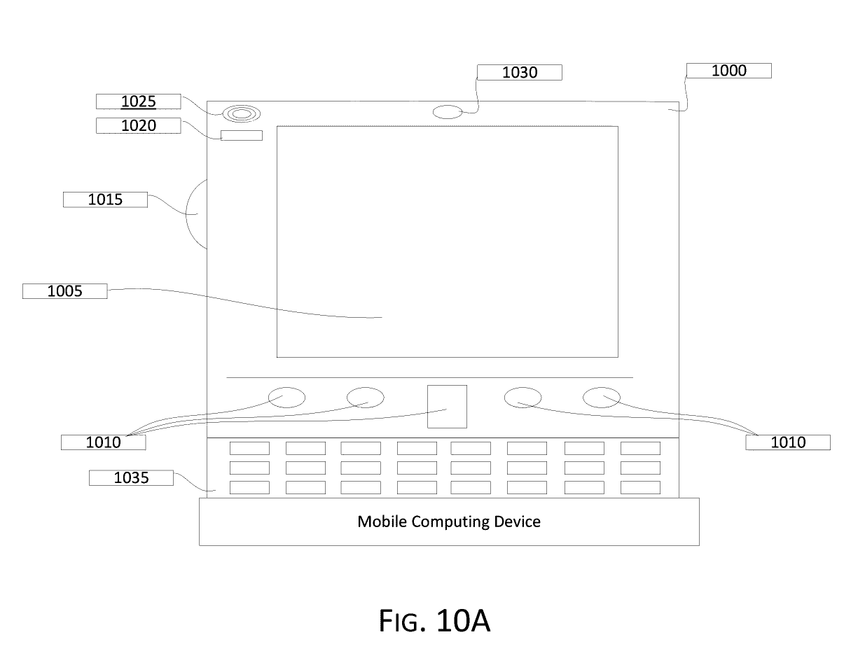

FIG. 1 illustrates an overview of an example system for improving recommendations from implicit feedback as described herein. Exemplary system 100 presented is a combination of interdependent components that interact to form an integrated whole for improving recommendations from implicit feedback. Components of the systems may be hardware components or software implemented on and/or executed by hardware components of the systems. In examples, system 100 may include any of hardware components (e.g., used to execute/run operating system (OS)), and software components (e.g., applications, application programming interfaces, modules, virtual machines, runtime libraries, etc.) running on hardware. In one example, an exemplary system 100 may provide an environment for software components to run, obey constraints set for operating, and makes use of resources or facilities of the system 100, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet) and/or any other electronic devices. As an example of a processing device operating environment, refer to the exemplary operating environments depicted in FIGS. 9-11. In other examples, the components of systems disclosed herein may be spread across multiple devices. For instance, input may be entered on a client device (e.g., processing device) and information may be processed or accessed from other devices in a network such as one or more server devices.

As one example, the system 100 comprises client computing device 102A, client computing device 102B, client computing device 102C, distributed network 104, and a distributed server environment comprising one or more servers such as server 106A, server 106B and server 106C. One of skill in the art will appreciate that the scale of systems such as system 100 may vary and may include more or fewer components than those described in FIG. 1. In some examples, interfacing between components of the system 100 may occur remotely, for example where components of system 100 may be spread across one or more devices of a distributed network.

The client computing devices 102A, 102B and 102C may be configured to generate and display viewing content to a user, and to transmit the viewed content to one or more of servers 106A, 106B and 106C via network 104. Server 106A, for example, may be configured to receive viewed content, to create/update an attention model based on the viewed content, to create/update a satisfaction and/or a fatigue model for the viewed content, and to integrate the satisfaction and/or a fatigue model into a recommendation system within server 106A. Server 106A may further be configured to create/update a profile based on the integration of the satisfaction and/or a fatigue model. The profile may comprise profile data associated with the user of client computing device 102A, for example. The profile data may include personal data, financial data, preferences, behavior data, psychographic data, geo-locations, dates and times, etc. The recommendation system may then provide recommendations based on the user profile. The recommendations may be transmitted by server 106A via network 104 to client computing device 102A. Client computing device 102A may receive and display the recommendations to the user.

In some aspects, the profile may be a single-user profile. In other aspects, the profile may be a global profile. For example, the users of client computing devices 102A, 102B and 102C may have no prior relationship or social connection. Server 106A may create a user profile based on viewed content received from client computing device 102A. Server 106A may then receive viewed content from computing device 102B. Accordingly, Server 106A may use the viewed content to update the attention model, satisfaction model, fatigue model and/or user profile, such that the user profile comprises profile data associated with the users of client computing devices 102A and 102B. Server 106A may then receive viewed content from computing device 102C, which Server 106A may use to further update the attention model, satisfaction model, fatigue model and/or user profile. After updating the user profile, the user profile comprises profile data associated with the users of client computing devices 102A, 102B and 102C; thus, representing a global profile. A global profile may be publicly accessible and/or modifiable by any computing device with access to network 104.

In yet other aspects, the profile may be a cohort profile. For example, the users of client computing devices 102A, 102B and 102C may be friends or may be associated with the same social group or organization. In other examples, the users of client computing devices 102A, 102B and 102C may not be acquainted, but may be located in the same area or region. Server 106A may create a user profile based on viewed content received from client computing device 102A. The user profile may be updated based on viewed content received from client computing device 102B. The user profile may further be updated based on viewed content received from client computing device 102C. After updating the user profile, the user profile comprises profile data associated with the users of client computing devices 102A, 102B and 102C; thus, representing a cohorts profile. A cohorts profile may only be accessible to or updatable by the users of client computing devices 102A, 102B and 102C and members of their social group or organization. Alternately, the cohorts profile may be accessible to any computing device located in the same area or region as at least one of computing devices 102A, 102B and 102C.

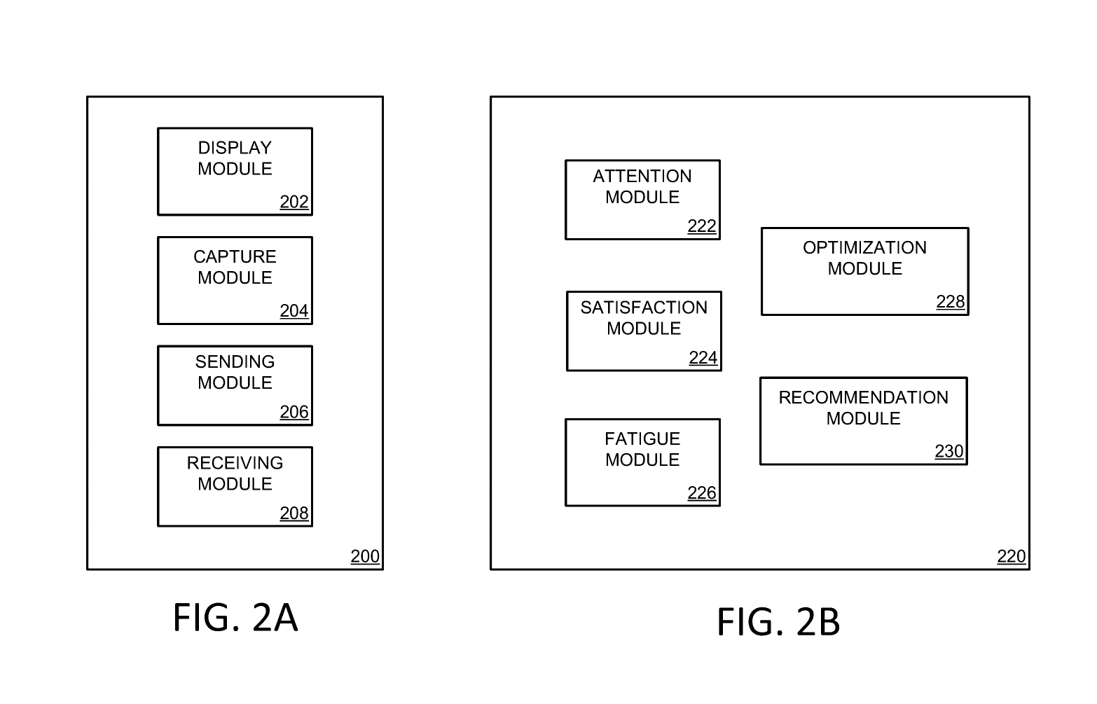

FIGS. 2A and 2B are diagrams of a client computing device and server, respectively, as described herein. The client computing device 200 comprises a display module 202, a capture module 204, a sending module 206, and a receiving module 208, each having one or more additional components. The display module 202 is configured to display content to a user via a user interface. For example, the display module may display recent news events associated with the location of the client computing device. A user may scroll through the news events in order to read some events and to ignore other events. The capture module 204 is configured to capture and store the user's viewing content data. The viewing content data may comprise information such as user swipes, user clicks, audio input, visual input, content type, content density, durations, visible areas, occluded areas, and other viewing pattern information. The sending module 206 is configured to receive the captured viewing data and to transmit the data to server 220. The receiving module 208 is configured to receive optimized recommendations from a recommendation system and to facilitate sending the optimized recommendations to the display module 202.

The server 220 may comprise an attention module 222, a satisfaction module 224, a fatigue module 226, an optimization module 228, and a recommendation system 230 each having one or more additional components. The attention module 222 may be configured to receive captured viewing data from client computing device 200 and to create/update an attention model. For example, upon receiving transmitted viewing data, attention module 222 may parse the viewing data into a plurality of viewports and cards. Each of the cards may be assigned or attributed a duration in order to designate that amount of time the card appeared or was visible in a viewport. The attributed durations from each viewport may then be aggregated to obtain the cumulative user attention for each card. In aspects, the cumulative user attention data may be used to create/update an attention model.

The satisfaction module 224 may be configured to convert the cumulative user attention data into user satisfaction data. In aspects, the satisfaction module 224 may receive and normalize the cumulative user attention data by card content density. For example, the normalization process may include determining the number of characters on each card or the size in pixels of each card. The information that results from the normalization process may then be used to create/update a satisfaction model.

The fatigue module 226 may be configured to determine the relevance of the satisfaction model data over time. For example, the fatigue module 226 may use the satisfaction model data to identity information related to the viewed content, such as the content and/or card types within the viewed content, the ratio of click cards (e.g., a card that requires a click to satisfy user's need) to non-click cards (e.g., a card that can satisfy a user's needs without a click), the time lapses between user revisits of previously viewed content, the time lapses before viewing content is updated or is available to be updated, etc. The fatigue module 226 may then use this information to determine how and to what degree the relevance of the satisfaction model data diminishes over time for users. In aspects, this information may be used to create/update a fatigue model.

The optimization module 228 may be configured to integrate the satisfaction model data and/or fatigue model data as implicit user feedback into a recommendation system. In aspects, the optimization module 228 may receive and use the satisfaction model data and/or fatigue model data to optimize the recommendations provided by a recommendation module 230. For example, the satisfaction model data and/or fatigue model data may be used to create or update a profile comprising profile data associated with the user of a client computing device. The profile may be used to determine recommendations to provide to the user of the client computing device. In exemplary aspects, the satisfaction model data and/or fatigue model data may be used to update the profile, thereby improving the recommendation selection process, the recommendation triggering process, the recommendation ranking and prioritization process, and/or the recommendation presentation process.

The recommendation module 230 may be configured to select and/or generate recommendations and to transmit the recommendations to client computing device 200. For example, recommendation module 230 may generate recommendations based on the information within a profile. The recommendation may be optimized as discussed with respect to optimization module 228. The optimized recommendation may then be transmitted to client computing device 200.

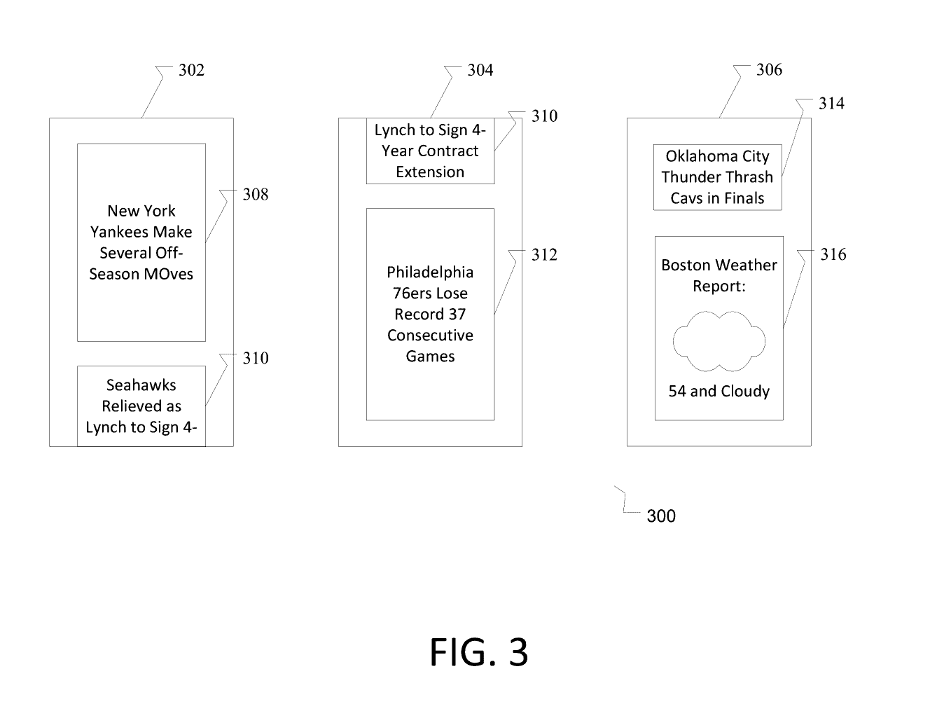

FIG. 3 illustrates the diagram of exemplary viewed content. Exemplary viewed content 300 comprises viewports 302, 304 and 306. Viewport 302 comprises card 308 and a portion of card 310. Viewport 304 comprises card 312 and a portion of card 310. Viewport 306 comprises cards 314 and 316. In aspects, a viewport may comprise a card, a portion of a card, or multiple portions of multiple cards. For example, viewport 302 comprises sports event card 308 and a portion of sports event card 310. Viewports within the same viewed content may comprise cards having different content types, different sizes or different content densities. The cards within a viewport may also have different content types, different sizes or different content densities. For example, viewport 304 comprises sports event card 312 and a portion of sports event card 310, whereas viewport 306 comprises sports event card 314 and weather event card 316.

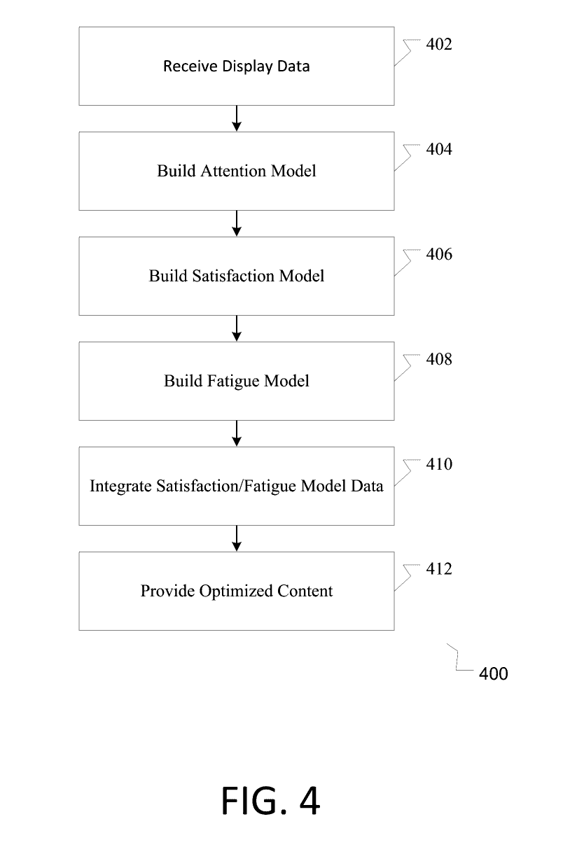

FIG. 4-8 illustrate various process flows associated with improving recommendations based at least upon implicit user feedback as described herein. In aspects, methods 400-800 may be executed by an exemplary system such as system 100 of FIG. 1. In examples, methods 400-800 may be executed on a device comprising at least one processor configured to store and execute operations, programs or instructions. However, methods 400-800 are not limited to such examples. In other examples, methods 400-800 may be performed on an application or service for providing recommendations. In at least one example, methods 400-800 may be executed (e.g., computer-implemented operations) by one or more components of a distributed network, for instance, web service/distributed network service (e.g. cloud service) to leverage recommendation generation and processing.

FIG. 4 illustrates an example method of improving recommendations from implicit user feedback as described herein. Exemplary method 400 begins at operation 402 where display data (e.g., viewing content) is received by one or more components of a recommendation system. In one example, an attention modeling component of a recommendation system may receive captured viewing data from a client computing device. The captured viewing data may refer to one or more viewports (e.g., data displayed in the display area of a client device) that define or describe the viewing experience for one or more users of the client computing device. A viewport may comprise a card, a portion of a card, multiple portions of multiple cards, or various document and/or webpage elements. In one example, viewing data may be captured by determining stabilized viewports (discussed in more detail below) during a viewing session. The stabilized viewports may be transmitted at preset intervals or may be transmitted when the viewing session ends. In another example, the viewing data may be streamed to the recommendation system, such that every user action (e.g., click, swipe, voice input, visual input, etc.) is recorded, stored and/or transmitted in real-time.

In operation 404, an attention model may be created/updated using the captured viewing data. In aspects, the captured viewing data may be parsed into a plurality of viewports and cards. A plurality of cards from each viewport may then be assigned or attributed a duration value designating the amount of time the card appeared or was visible in a viewport. The attributed durations for the cards in the viewports may then be aggregated to obtain the cumulative user attention for each card. In aspects, the cumulative user attention data may be used to create/update an attention model. In one example, the cumulative user attention data may be provided to a rule-based model that is instantiated by specifying rules to reflect user viewing patterns. In another example, the cumulative user attention data may be provided to a statistical analysis device or a component of the recommendation system operable to perform statistical analysis. The statistical analysis device may comprise or have access to a machine learning regression model that processes the cumulative user attention data by representing user viewing patterns as features and using eye-tracking data collected from controlled use studies as labels.

In operation 406, a satisfaction model may be created/updated using the cumulative user attention data. In aspects, the cumulative user attention data is normalized by the content density of the cards associated with the data. Content density may be expressed, for example, by the number of characters in a card or the size in pixels of a card. Measuring content density in such a manner allows for accurate comparisons across a heterogeneous population of content and/or card types. In some aspects, the normalized user attention data is an accurate proxy of user satisfaction for cards that can satisfy users without clicks, as well as for cards that require clicks to satisfy users. The normalized attention data may then be used to create/update a satisfaction model. The satisfaction model may be a hybrid model based on user-defined rules and optimal thresholds that are derived by analyzing data distribution and long-term engagement metrics.

In operation 408, a fatigue model may be created/updated using the satisfaction model, the normalized user attention data, and/or the cumulative user attention data. In aspects, new captured viewing data may be received from the client computing device of operation 402. Additionally, data associated with the content and/or card types may be received from the cumulative user attention data and/or the normalized user attention data. The new captured viewing data and the associated content and/or card type data may be used to determine that the initial captured viewing data of operation 402 has been changed, deleted, updated or otherwise modified. Based on this determination, a fatigue model may then determine that the information associated with the viewed content is no longer relevant or useful to the user. Accordingly, a fatigue score may be generated and/or the fatigue models may be trained to degrade the relevance of the initial captured viewing data.

In operation 410, the satisfaction model data and/or the fatigue model data may be used as implicit feedback to an electronic recommendation system. In aspects, inferences of user attention, user satisfaction and user fatigue determined from at least the user attention model, the user satisfaction model, and/or the user fatigue model are used to improve various features of the electronic recommendation system. For example, inferences of user satisfaction may be used to improve the content selection of recommendations provided by the recommendation system. Inferences of user fatigue may be used to improve the content triggering of recommendations provided by the recommendation system. Similarly, the inferences of user satisfaction and/or user fatigue may be used to improve the ranking of ranking and prioritization of recommendations provided by the recommendation system. Moreover, the inferences of user satisfaction and/or user fatigue may be used to improve the content presentation of recommendations provided by the recommendation system.

In operation 412, the recommendation system may provide to a client computing device recommendation content that has been optimized using the implicit feedback. The optimized recommendation may be displayed in a display area of the client computing device. The optimized recommendation content improves the user experience by reducing the amount time the user wastes searching for desirable content; reducing the amount of time the user wastes waiting for new content to be displayed; increasing the accuracy of recommendations; and proactively providing the user with relevant content.

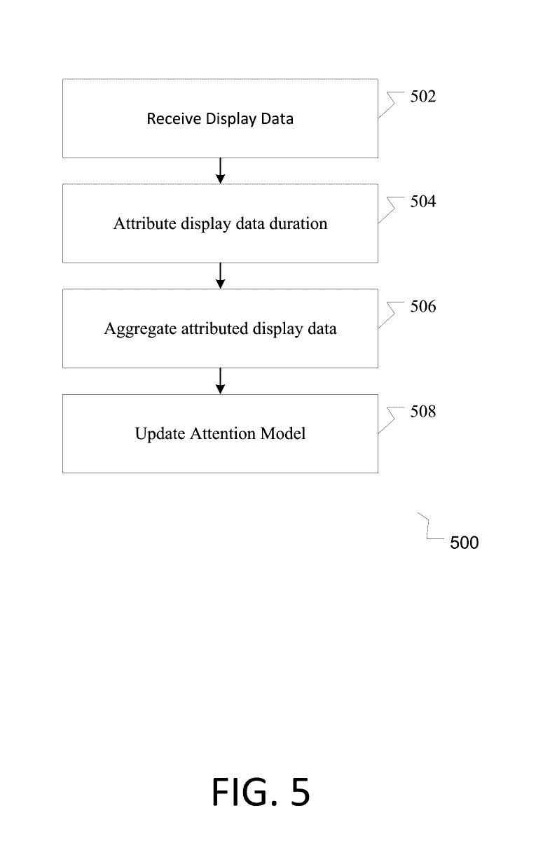

FIG. 5 illustrates an example method of creating and/or updating an attention model to infer user attention as described herein. Exemplary method 500 may begin at operation 502 where display data (e.g., user viewing content) is received by one or more components of a recommendation system or service. In one example, an attention modeling component of a recommendation system may receive captured viewing data from a client computing device. The captured viewing data may comprise one or more viewports (e.g., data displayed in the display area of a client device) that define or describe the viewing experience for one or more users of the client computing device. A viewport may comprise data including a card, a portion of a card, multiple portions of multiple cards, or various document and/or webpage elements.

At operation 504, the captured viewing data may be parsed by an attention modeling component or by software accessible to the recommendation system. The captured viewing data may be parsed into a plurality of individual viewports, which may further be parsed into a plurality of individual cards. The individual cards may be assigned or attributed a duration value designating the amount of time the card appeared or was visible in a stabilized viewport. A stabilized viewport, as used herein, may refer to a viewport that is not in motion and/or has not been swiped by a user for a requisite time period (e.g., 200 milliseconds). An attributed duration may correlate to accurate inferences of user attention to viewing content by accounting for user viewing patterns. Viewing patterns may be determined in various ways. For example, viewing patterns may be based on stabilized viewports. During a stabilized viewport, most of the user attention may be focused on the upper portion of the display area of a client computing device. When the client computing device receives an indication to switch to a different viewport or to open a menu, the user attention may be shifted to a different portion of the screen. In one example, when the client computing device receives an indication that the display screen has been swiped up (e.g., a change viewport request), the user attention is shifted from the top half of the screen to the lower half of the screen where the new content scrolls onto the screen. In such an example, a viewing pattern may be determined such that the areas of the viewport where user attention is focused may be attributed a longer duration or may weigh more heavily in a duration calculation. In another example, viewing patterns may be determined by excluding noise accumulated from swiping and/or changing between viewports, such that only the longest continuous viewport durations are factored into a duration. In yet another example, viewing patterns may be determined by excluding areas that are being touched by users (such that the underlying content is occluded) or are otherwise obscured.

In operation 506, an attention modeling component may aggregate the duration-attributed cards from each of the viewports to obtain the cumulative user attention for each card. For example, referring back to FIG. 300, portions of card 310 appear in both viewports 302 and 304. In one example, viewports 302 and 304 may have been viewed for 10 and 6 seconds, respectively. By determining viewing patterns as non-exhaustively discussed above, the attention modeling component may attribute a duration of 8 seconds for card 308, 2 seconds for card 310 of viewport 302, 4 seconds for card 310 of viewport 304, and 2 seconds for card 312. The attention modeling component may then aggregate the combined durations for each card such that card 308 is attributed a duration of 8 seconds, card 310 is attributed a duration of 6 seconds, and card 312 is attributed a duration of 2 seconds.

In operation 508, aggregated, duration-attributed card data is used to create/update an attention model and/or an attention modeling component. In aspects, an attention model may be a rule-based model that is instantiated by specifying rules to reflect user viewing patterns. In other aspects, an attention model may be a machine learning regressor or classifier that represents viewing patterns as features and uses eye-tracking data collected from controlled use studies as labels. Methods for creating, updating, and/or training statistical models are well-known to those skilled in the art.

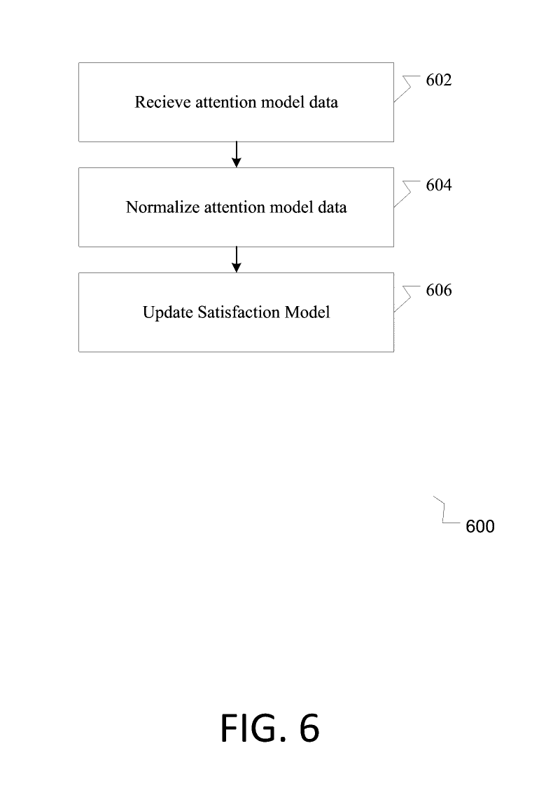

FIG. 6 illustrates an example method of creating and/or updating a satisfaction model to infer user satisfaction as described herein. Exemplary method 600 may begin at operation 602 where aggregated duration-attributed card data and/or attention model data is received by one or more components of a recommendation system or service. In one example, a satisfaction modeling component of a recommendation system may receive this data from an attention modeling component of the recommendation system.

In operation 604, a satisfaction modeling component may normalize the data to allow for accurate comparisons across a heterogeneous population of content and/or card types. In aspects, a content type or card type may refer to the type of information on a card or the presentation of information of a card. For example, referring back to FIG. 300, viewport 306 comprises cards 314 and 316. Card 314 comprises sports event information and is text-based. Accordingly, Card 314 may be designated a content type of “sports event” and a card type of “text only.” Card 316 comprises weather event information and is image and text-based. Accordingly, Card 316 may be designated a content type of “weather event” and a card type of “text/image.”

The data may be normalized according to several factors. In some aspects, the data may be normalized according to the content density of the card from which the data was gathered. Content density may be expressed, for example, by the number of characters in a card, size in pixels of a card, content type, card type, or some combination thereof. For example, some cards, such as weather event cards, comprise sparser text and require less attention to satisfy user needs. Other cards, such as news event cards, comprise denser text and require more attention to satisfy user needs. In such examples, weather event cards and news event cards may be accorded different weights during, or as a result of, the normalization process.

In some aspects, while normalized viewport-based attention data is an accurate proxy of user satisfaction for cards that do not require clicks to satisfy user needs (e.g., a “click-less” card), the normalized attention data may also improve inferences of user satisfaction for cards that do require a click to satisfy user needs (e.g., a “click” card). For example, using the normalized attention data, a recommendation system may determine whether an unclicked click card was not clicked due to relevance or visibility. Such a determination may be important because a card that was viewed and not clicked is likely to indicate dissatisfaction with the card, whereas a card that was not viewed and not clicked may not indicate dissatisfaction. As another example, using the normalized attention data, a recommendation system may improve the estimation of click satisfaction on a landing page. For instance, a landing page is likely to be more relevant and/or satisfying if the viewport changing behavior is less frequent than another landing page with more viewport changes during the similar viewing time or dwell time.

In operation 608, normalized attention data may be used to create/update a satisfaction model and/or the satisfaction modeling component. In aspects, the satisfaction model may be a model as discussed with respect to the attention model of method 500. Additionally, the satisfaction model may incorporate data regarding the click and click-less cards, content and card types, and optimal thresholds related normalized attention. In some aspects, the optimal thresholds may be determined by analyzing data distribution and correlating viewport data with long-term engagement metrics (e.g., page views per user) and/or human judgement from controlled user studies or editorial tasks.

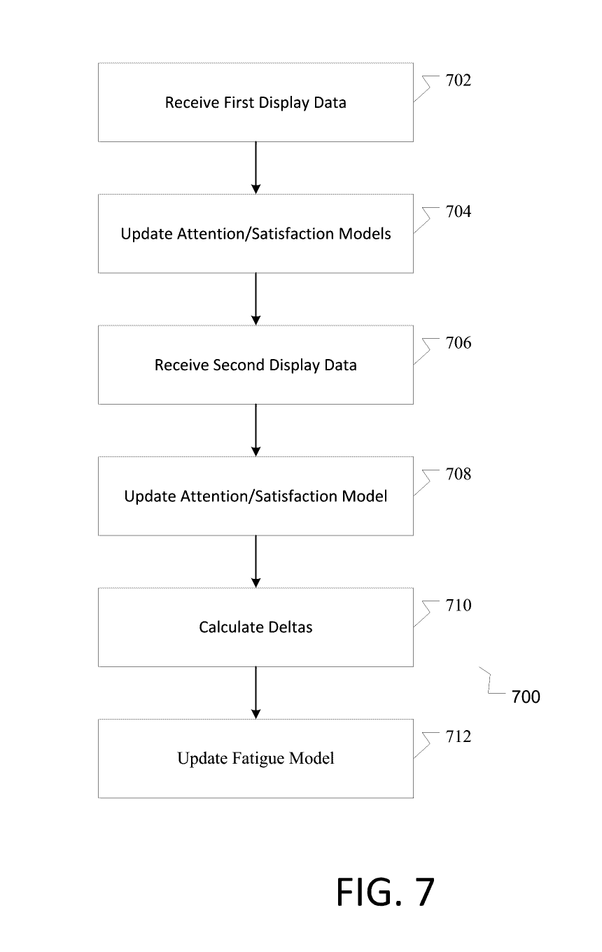

FIG. 7 illustrates an example method of creating and/or updating a fatigue model to infer user fatigue as described herein. Exemplary method 700 may begin at operation 702 where a first display data may be received by one or more components of a recommendation system, as discussed above with respect to method 400. The first display data may represent raw viewport data from the first viewing session of a user. In operation 704, the first display data may be received, parsed, attributed durations and aggregated, as discussed above with respect to method 500. After a user attention model has been updated using the first aggregated duration data, the first aggregated duration data may be received, normalized and used to update a satisfaction model, as discussed above with respect to method 600.

In operation 706, a second display data may be received by one or more components of the recommendation system, as discussed above with respect to method 400. The second display data may represent raw viewport data from the second viewing session of the user. In operation 708, the second display data may be received, parsed, attributed durations and aggregated, as discussed above with respect to method 500. After the user attention model has been updated using the second aggregated duration data, the second aggregated duration data may be received, normalized and used to update the satisfaction model, as discussed above with respect to method 600.

In operation 710, a fatigue model component may calculate or otherwise determine the differences between the data generated by the first display data and the data generated from the second display data. In aspects, a fatigue model component may receive and compare the first aggregated duration data and the second aggregated duration data. The comparison may include factors such as duration time, content type, card type, card density, viewing patterns, thresholds, etc. The comparison may generate a set of data identifying the differences between the first aggregated duration data and the second aggregated duration data. In some aspects, this set of data may be used to infer user fatigue with the display data. For example, the weather event card may be generally relevant for users who routinely check the daily weather forecast in the morning. However, once a user has viewed the weather card on a particular morning, the relevance of that weather card diminishes unless there is a substantial change in the weather card from the last time the user viewed it or sufficient time has lapsed for it to be interesting, relevant and/or useful again (e.g., the next morning).

In operation 712, the set of data identifying the differences may be used to create/update a fatigue model and/or the fatigue modeling component. In aspects, the fatigue model may be a model as discussed with respect to the attention model of method 500. In some examples, the set of data may not identify any differences between the first aggregated duration data and the second aggregated duration data. In such examples, the set of data may be discarded or the set of data may still be applied to the fatigue model and/or the fatigue modeling component.

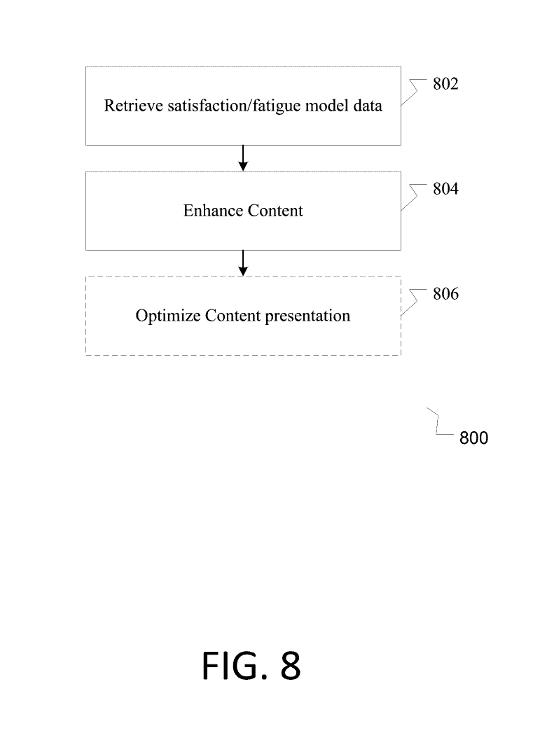

FIG. 8 illustrates an example method of improving recommendation content as described herein. Exemplary method 800 may begin at operation 802 where a recommendation component of a recommendation system may receive satisfaction model data and/or fatigue model data. In aspects, the recommendation component uses the satisfaction model data and/or fatigue model data to update the decision process of the recommendation component. For example, the recommendation component may integrate the viewport-based inferences as implicit user feedback in order to enhance the quality and accuracy of the recommendations provided by the recommendation system. In some aspects, the recommendation component may create/update a profile based on the received satisfaction and/or a fatigue model data prior to generating recommendation content. The profile may be a single-user profile, global profile or a cohort profile as discussed with respect to system 100.

In operation 804, a recommendation component may enhance the recommendation content. In some aspects, the enhancements include improving recommendation content selection, based on inferred user satisfaction or inferred user fatigue. For example, the recommendation system may prioritize and/or fetch recommendation content that provides the largest inferences of user satisfaction. This prioritization may decrease the amount of time users must sift through recommendation results and may decrease the amount of processing that must be performed on larger recommendation sets that include marginally satisfactory recommendations. As another example, the recommendation system may prioritize and/or fetch recommendation content based on inferences of a user's degraded interest in the display data. For instance, the priority of content may be based on the novelty of the content, such that more recent content is prioritized above less recent content.

In some aspects, the enhancements include improving recommendation content triggering. Content triggering, as used herein, may refer to the determination to provide or check for new recommendations. This determination may include a scoring function that receives and processes contextual factors, such as time of day, day of week, location, content relevance, content type, card type, elapsed time since the last recommendations were provided, user behavior, and/or user demographics. In one example, the scoring function may be a static algorithm, such that a finite number of factors are accepted and/or expected as input. Each input factor may be assigned a value and/or weight. The static algorithm adds the values of each weighted factor to generate a final score. In another example, the scoring function may be a dynamic algorithm that can be modified and/or learned by training a statistical model using the inferred satisfaction data and/or the inferred fatigue labels. In yet another example, the scoring function may be a hybrid of both the static and dynamic algorithms discussed above. In such aspects, a score generated by the scoring function may be compared to a threshold triggering value. In aspects, when a score exceeds the threshold triggering value, a search for new and/or updated recommendation content commences.

In some aspects, the enhancements include improving recommendation content ranking. For example, after recommendation content has been selected, the recommendations may be ranked using factors associated with user satisfaction and/or user fatigue. As one example, recommendations for sports events may be ranked according to the behavioral history of the user. The behavioral history may include tickets purchased for past sporting event, indications of favorite sports and sport teams, the reading history of sports news articles, etc. As another example, recommendations for restaurants may be ranked according to the geolocational proximity of the restaurants to the client computing device. As yet another example, recommendations for news events may be ranked according to the “buzz” or interest generated by the event on a local, national or global scale. In aspects, the recommendation rankings may also be improved by training a machine learning model using the implicit user feedback as online features that are routinely updated (e.g., daily, hourly, etc.) and as labels for training the machine learning model offline. Although specific examples of implicit user feedback are provided herein in reference to user fatigue and user satisfaction, other variants of implicit user feedback are contemplated. For example, implicit user feedback may be derived by conditioning contextual factors, such as time, location, card types, content types, and user groups.

In optional operation 804, a recommendation component may optimize the presentation of the enhanced recommendation content. In some aspects, the recommendation component may group and/or sort enhanced recommendation according to various factors, such as content type, card type, user behavior, etc. For example, in a viewing session, a user may tend to browse through content in the order: news events, sports events, financial events, and then weather events. The recommendation component may group the news events cards together and display them first, instead of having the news events cards interspersed between the other content types. Additionally, the recommendation component may alter the look of the card content. For example, a recommendation component may reduce the content density of a particularly dense card in order to increase the readability of the card. In aspects, after optimizing the presentation of the enhanced recommendation content, the recommendations are transmitted to the client computing device.

FIGS. 9-11 and the associated descriptions provide a discussion of a variety of operating environments in which examples of the invention may be practiced. However, the devices and systems illustrated and discussed with respect to FIGS. 9-11 are for purposes of example and illustration and are not limiting of a vast number of computing device configurations that may be utilized for practicing examples of the invention, described herein.

FIG. 9 is a block diagram illustrating physical components of a computing device 902, for example a component of a system with which examples of the present disclosure may be practiced. The computing device components described below may be suitable for the computing devices described above. In a basic configuration, the computing device 902 may include at least one processing unit 904 and a system memory 906. Depending on the configuration and type of computing device, the system memory 906 may comprise, but is not limited to, volatile storage (e.g., random access memory), non-volatile storage (e.g., read-only memory), flash memory, or any combination of such memories. The system memory 906 may include an operating system 907 and one or more program modules 908 suitable for running software applications 920 such as application 928, IO manager 924, and other utility 926. As examples, system memory 906 may store instructions for execution. Other examples of system memory 906 may be components such as a knowledge resource or learned program pool, as examples. The operating system 907, for example, may be suitable for controlling the operation of the computing device 902. Furthermore, examples of the invention may be practiced in conjunction with a graphics library, other operating systems, or any other application program and is not limited to any particular application or system. This basic configuration is illustrated in FIG. 9 by those components within a dashed line 922. The computing device 902 may have additional features or functionality. For example, the computing device 902 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 906. While executing on the processing unit 904, the program modules 908 (e.g., application 928, Input/Output (I/O) manager 924, and other utility 926) may perform processes including, but not limited to, one or more of the stages of the operational method 400 illustrated in FIG. 4, for example. Other program modules that may be used in accordance with examples of the present invention may include electronic mail and contacts applications, word processing applications, spreadsheet applications, database applications, slide presentation applications, input recognition applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 902 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 902 may also have one or more input device(s) 912 such as a keyboard, a mouse, a pen, a sound input device, a device for voice input/recognition, a touch input device, etc. The output device(s) 914 such as a display, speakers, a printer, etc. may also be included. The aforementioned devices are examples and others may be used. The computing device 904 may include one or more communication connections 916 allowing communications with other computing devices 918. Examples of suitable communication connections 916 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 906, the removable storage device 909, and the non-removable storage device 910 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 902. Any such computer storage media may be part of the computing device 902. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

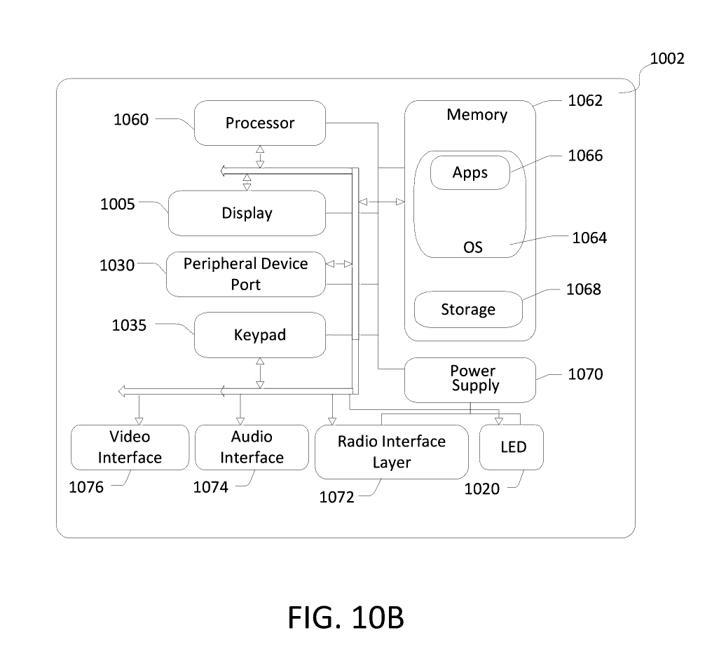

FIGS. 10A and 10B illustrate a mobile computing device 1000, for example, a mobile telephone, a smart phone, a personal data assistant, a tablet personal computer, a laptop computer, and the like, with which examples of the invention may be practiced. For example, mobile computing device 1000 may be implemented as system 100, components of systems 100 may be configured to execute processing methods as described in FIG. 4, among other examples. With reference to FIG. 10A, one example of a mobile computing device 1000 for implementing the examples is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative examples, mobile computing device 1000 may incorporate more or less input elements. For example, the display 1005 may not be a touch screen in some examples. In yet another alternative example, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various examples, the output elements include the display 1005 for showing a graphical user interface (GUI), a visual indicator 1020 (e.g., a light emitting diode), and/or an audio transducer 1025 (e.g., a speaker). In some examples, the mobile computing device 1000 incorporates a vibration transducer for providing the user with tactile feedback. In yet another example, the mobile computing device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one example of a mobile computing device. That is, the mobile computing device 1000 can incorporate a system (i.e., an architecture) 1002 to implement some examples. In examples, the system 1002 is implemented as a “smart phone” capable of running one or more applications (e.g., browser, e-mail, input processing, calendaring, contact managers, messaging clients, games, and media clients/players). In some examples, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000, including application 928, IO manager 924, and other utility 926 described herein.

The system 1002 has a power supply 1070, which may be implemented as one or more batteries. The power supply 1070 might further include an external power source, such as an AC adapter or a powered docking cradle that supplements or recharges the batteries.

The system 1002 may include peripheral device port 1078 that performs the function of facilitating connectivity between system 1002 and one or more peripheral devices. Transmissions to and from the peripheral device port 1072 are conducted under control of the operating system 1064. In other words, communications received by the peripheral device port 1078 may be disseminated to the application programs 1066 via the operating system 1064, and vice versa.

The system 1002 may also include a radio 1072 that performs the function of transmitting and receiving radio frequency communications. The radio 1072 facilitates wireless connectivity between the system 1002 and the “outside world,” via a communications carrier or service provider. Transmissions to and from the radio 1072 are conducted under control of the operating system 1064. In other words, communications received by the radio 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated example, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with examples of the present invention, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio 1072 or via a distributed computing network. Similarly, such data/information may be readily transferred between computing devices for storage and use according to well-known data/information transfer and storage means, including electronic mail and collaborative data/information sharing systems.

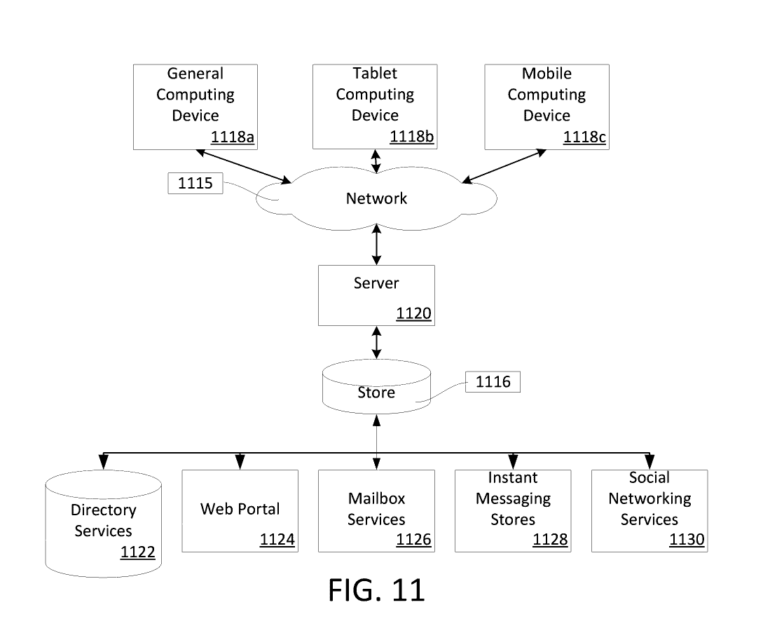

FIG. 11 illustrates one example of the architecture of a system for providing an application that reliably accesses target data on a storage system and handles communication failures to one or more client devices, as described above. Target data accessed, interacted with, or edited in association with application 928, IO manager 924, other utility 926, and storage may be stored in different communication channels or other storage types. For example, various documents may be stored using a directory service 1122, a web portal 1124, a mailbox service 1126, an instant messaging store 1128, or a social networking site 1130, application 928, IO manager 924, other utility 926, and storage systems may use any of these types of systems or the like for enabling data utilization, as described herein. A server 1120 may provide storage system for use by a client operating on general computing device 902 and mobile device(s) 1000 through network 1115. By way of example, network 1115 may comprise the Internet or any other type of local or wide area network, and client nodes may be implemented as a computing device 902 embodied in a personal computer, a tablet computing device, and/or by a mobile computing device 1000 (e.g., a smart phone). Any of these examples of the client computing device 902 or 1000 may obtain content from the store 1116.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A system for modeling user satisfaction, the system comprising:
at least one processor; and
memory coupled to the at least one processor, the memory comprising computer executable instructions that, when executed by the at least one processor, performs a method comprising:
receiving a first viewing session data;
determining at least a first content item in the first viewing session data, wherein the at least a first content item has a first content type;
determining a first aggregated display time for the first content type;
determining a first content density for the first content type;
generating a first viewing time based on the first aggregated display time for the first content type and the first content density for the first content type;
determining a satisfaction value for the first content type; and
updating a satisfaction model based on the satisfaction value.

2. The system of claim 1, wherein first session viewing data comprises one or more viewports, the one or more viewports comprising at least a portion of one or more content items.

3. The system of claim 1, wherein determining the first aggregated display time comprises aggregating one or more content items in the viewing session data and attributing a duration to each of the aggregated one or more content items.

4. The system of claim 3, wherein an attributed duration of the one or more content items determines a display time for one or more content items, wherein the display time is based on the visible area of the one or more content items within the one or more viewports.

5. The system of claim 4, wherein the visible area excludes occluded areas within the viewing session data.

6. The system of claim 1, wherein determining a first content density comprises determining at least one of: the number of characters within the first content item and the size in pixels of the first content item.

7. The system of claim 1, wherein the first viewing time is used to update an attention value.

8. The system of claim 1, wherein the satisfaction model is one of: a rule-based model, a machine-learned regressor, and a machine-learned classifier.

9. The system of claim 1, further comprising:
receiving a second viewing session data;
determining at least a second content item in the second viewing session data, wherein the at least a second content item has the first content type;
determining a second aggregated display time for the first content type;
determining a second content density for the first content type;
generating a second viewing time based on the aggregated display time for the first content type and the second content density for the first content type;
comparing the first viewing time to the second viewing time; and
determining a fatigue value based at least on the comparison.

10. The system of claim 9, wherein the fatigue value is further based at least on determining whether the at least a first content item is different from the at least a second content item.

11. The system of claim 10, wherein the fatigue model is updated based on the fatigue value.

12. The system of claim 10, further comprising: optimizing a presentation of the first content type based upon at least one of: the satisfaction value and the fatigue value.

13. The system of claim 10, wherein optimizing a presentation of the first content type comprises prioritizing the first content type by at least one of: content type selection, content type triggering, and content type ranking.

14. A system for providing recommendations using viewable content, the system comprising:
a processor;
a recommendation component; and
a memory coupled to the processor, the memory comprising computer executable instructions that, when executed by the processor, performs a method comprising:
receiving viewing session data;
creating an user attention model from the received viewing session data;
using the attention model, creating a satisfaction model for the received viewing session data;
selecting a content selection related to the received viewing session data;
using the satisfaction model, prioritizing as prioritized content a portion of content from at least one of the viewing session data and the content selection related to the viewing session data; and
integrating the prioritized content with the recommendation component.

15. The system of claim 14, further comprising: using the satisfaction model, creating a fatigue model for the received viewing session data.

16. The system of claim 14, wherein selecting a content selection comprises:
determining a criteria in the received viewing session data, wherein the criteria is at least one of: a content type, a time, a location, a user, and a user group; and
selecting content with the criteria.

17. The system of claim 14, wherein the prioritized content is prioritized based on at least one of: a content of the content selection and a ranking of the content selection.

18. The system of claim 14, wherein the recommendation component provides recommendations based at least upon the prioritized content.

19. The system of claim 14, wherein the recommendation component updates a profile based upon at least one of the attention model, the satisfaction model, and the prioritized content.

20. A method for providing recommendations using viewable content, the method comprising:
receiving a first viewing session data;
determining at least a first content in the first viewing session data, wherein the first content has a first content type;
determining a first aggregated display time for the first content type;
generating a first viewing time based on the first aggregated display time for the first content type;
determining a satisfaction value for the first content type;
receiving a second viewing session data;
determining at least a second content in the second viewing session data, wherein the second content has the first content type;
determining a second aggregated display time for the first content type;
generating a second viewing time based on the second aggregated display time for the first content type;
comparing the first viewing time and the second viewing time;
determining a fatigue value based at least on the comparison; and
providing a recommendation based at least in part on at least one of the satisfaction value and the fatigue value.
